(19) United States
(12) Patent Application Publication
(10) Pub. No.: US 2026/0184272 A1
(43) Pub. Date: Jul. 2, 2026

(54) RELAY DEVICE, UNAUTHORIZED FRAME DETECTION METHOD, AND IN-VEHICLE DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Shogo KAMIGUCHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/130,296

(22) PCT Filed: Nov. 2, 2023
(86) PCT No.: PCT/JP2023/039641

§ 371 Date: May 15, 2025

(30) Foreign Application Priority Data
Nov. 17, 2022 (JP) 2022-184354

(51) Int. Cl. B60R 16/023; H04L 12/22; H04L 12/46

(52) U.S. Cl. CPC B60R 16/023; H04L 12/4604; H04L 12/22

(57) ABSTRACT

A relay device is a relay device that, in an in-vehicle network to which a plurality of in-vehicle devices are connected, relays frames among the plurality of in-vehicle devices. The relay device includes: a reception unit configured to, in a case where an unauthorized frame is detected by an in-vehicle device among the plurality of in-vehicle devices, receives a request to start detecting an unauthorized frame from the in-vehicle device; and a detection unit capable of executing detection processing that detects an unauthorized frame among frames transmitted over the in-vehicle network. In a case where the request to start is received by the reception unit in a stopped state in which the detection processing is stopped, the detection unit transitions from the stopped state to an executing state in which the detection processing is executed.

### CROSS-REFERENCE TO RELATED APPLICATIONS

This application is the U.S. national stage of PCT/JP2023/039641 filed on Nov. 2, 2023, which claims priority of Japanese Patent Application No. JP 2022-184354 filed on Nov. 17, 2022, the contents of which are incorporated herein.

### TECHNICAL FIELD

The present disclosure relates to a relay device, an unauthorized frame detection method, and an in-vehicle device.

### BACKGROUND

A vehicle is equipped with a variety of in-vehicle devices, such as control-type electronic control units (ECUs) that control the engine, the transmission, and the like; body control modules (BCMs) that control the headlights, power windows, and the like; and information type ECUs such as navigation devices, multimedia devices, and the like. The in-vehicle devices are connected to an in-vehicle network and are capable of communicating with one another.

Unauthorized control of vehicles, where an unauthorized in-vehicle device impersonates an authorized in-vehicle device, connects to the in-vehicle network, and transmits unauthorized frames to the in-vehicle network, is becoming a problem. Techniques for detecting unauthorized frames in in vehicle networks have therefore been proposed.

International Publication No. 2021/145116 discloses an in-vehicle network system in which, in an in-vehicle network to which a plurality of electronic control units (ECUs) and a GW-ECU that relays the connections of the ECUs are connected, each ECU is provided with a function for detecting unauthorized messages (frames), and an unauthorized message detection result from each ECU is stored in the GW-ECU. In the in-vehicle network system disclosed in International Publication No. 2021/145116, unauthorized messages are detected individually at each ECU.

International Publication No. 2019/116973 discloses a network system in which, in an in vehicle network to which a plurality of ECUs and a plurality of E-switches that relay the connections of the ECUs are connected, each E-switch is provided with a function for detecting unauthorized frames. In the network system disclosed in International Publication No. 2019/116973, unauthorized frames are collectively detected at the E-switches rather than in each ECU.

However, with the in-vehicle network system disclosed inInternational Publication No. 2021/145116, only the messages received by each ECU are subject to the unauthorized message detection processing. Therefore, the messages transmitted over the in-vehicle network cannot be processed comprehensively, and unauthorized messages may fail to be detected.

On the other hand, in the network system disclosed in International Publication No. 2019/116973, frames transmitted over the network can be processed comprehensively at the E-switches, but the processing load on the E-switches is high. When a large number of frames flow over the network, it is difficult for the E-switches to complete the processing.

### SUMMARY

A relay device according to one aspect of the present disclosure is a relay device that, in an in-vehicle network to which a plurality of in-vehicle devices are connected, relays frames among the plurality of in-vehicle devices, the relay device including: a reception unit configured to, in a case where an unauthorized frame is detected by an in-vehicle device among the plurality of in-vehicle devices, receive a request to start detecting an unauthorized frame from the in vehicle device; and a detection unit capable of executing detection processing that detects an unauthorized frame among frames transmitted over the in-vehicle network. wherein in a case where the request to start is received by the reception unit in a stopped state in which the detection processing is stopped, the detection unit transitions from the stopped state to an executing state in which the detection processing is executed.

### Effects

According to the present disclosure, frames flowing over an in-vehicle network can be comprehensively subjected to unauthorized frame detection while suppressing the processing load on a relay device.

### BRIEF DESCRIPTION OF DRAWINGS

FIG. 1 is a block diagram illustrating an example of the configuration of an in-vehicle system according to an embodiment.

FIG. 2 is a block diagram illustrating an example of the configuration of a relay ECU according to the embodiment.

FIG. 3 is a block diagram illustrating an example of the configuration of an ECU according to the embodiment.

FIG. 4 is a function block diagram illustrating an example of the functions of the in-vehicle system according to the embodiment.

FIG. 5 is a state transition diagram illustrating transitions in an executing state of second detection processing performed by a second detection unit.

FIG. 6 is a diagram illustrating an example of a correspondence table.

FIG. 7 is a diagram illustrating an example of first detection processing.

FIG. 8 is a diagram illustrating an example of the second detection processing.

FIG. 9 is a diagram illustrating another example of the first detection processing.

FIG. 10 is a diagram illustrating an example of the second detection processing.

FIG. 11 is a diagram illustrating an example of a notification screen.

FIG. 12 is a sequence chart illustrating an example of operations by the in-vehicle system according to the embodiment.

### DETAILED DESCRIPTION OF PREFERRED EMBODIMENTS

An overview of embodiments of the present disclosure will be given hereinafter.

In a first aspect, a relay device according to the present embodiment is a relay device that, in an in-vehicle network to which a plurality of in-vehicle devices are connected, relays frames among the plurality of in-vehicle devices, the relay device including: a reception unit configured to, in a case where an unauthorized frame is detected by an in-vehicle device among the plurality of in-vehicle devices, receive a request to start detecting an unauthorized frame from the in vehicle device; and a detection unit capable of executing detection processing that detects an unauthorized frame among frames transmitted over the in-vehicle network, wherein in a case where the request to start is received by the reception unit in a stopped state in which the detection processing is stopped, the detection unit transitions from the stopped state to an executing state in which the detection processing is executed. Through this, the detection processing by the relay device is in the stopped state until an unauthorized frame is detected by an in-vehicle device, and the processing load on the relay device can therefore be suppressed. Furthermore, if the detection processing is executed, unauthorized frames can be detected comprehensively among frames flowing over the in-vehicle network.

In a second aspect according to the first aspect, the relay device may be connected to a plurality of communication lines constituting the in-vehicle network, and the detection unit may take frames transmitted on a communication line, among the plurality of communication lines, to which the in-vehicle device that transmitted the request to start is connected, as a subject of the detection processing. Through this, unauthorized frames can be detected efficiently.

In a third aspect according to the second aspect, the request to start may include specifying information specifying a communication line, among the plurality of communication lines, to which the in vehicle device that has detected the unauthorized frame is connected. Through this, frames flowing through the communication line specified by the specifying information can be taken as the subject of the detection processing.

In a fourth aspect according to the first or the second aspect, the request to start may include a result of detecting the unauthorized frame by the in-vehicle device. Through this, the relay device can use the result of detecting unauthorized frames in the in-vehicle device in the detection processing.

In a fifth aspect according to any one of the first through the fourth aspects, the detection unit may take the frames relayed among the plurality of in-vehicle devices as a subject of the detection processing. Through this, frames not destined for the relay device can be taken as the subject of the detection processing, and unauthorized frames can be detected comprehensively among the frames relayed by the relay device.

In a sixth aspect according to any one of the first through the fifth aspects, the detection processing may be processing that, in a case where the unauthorized frame is detected by the in-vehicle device among frames of a first type, detects the unauthorized frame among frames of the first type on the basis of frames of a second type different from the first type. Through this, unauthorized frames can be detected efficiently, taking frames of the same first type as the unauthorized frame detected by the in-vehicle device as the subject of the detection processing.

In a seventh aspect according to any one of the first through the sixth aspects, the detection processing may be processing that detects the unauthorized frame among frames of a plurality of types. Through this, unauthorized frames can be detected comprehensively among a plurality of types of frames flowing over the in-vehicle network.

In an eighth aspect according to any one of the first through the seventh aspects, the detection processing may be processing that, on the basis of a timing of transmission of frames of a first type and a timing of transmission of frames of a second type different from the first type, detects the unauthorized frame among frames of the first type. Through this, unauthorized frames can be detected with high accuracy using not only the timing of the transmission of the first type of frames, but also the timing of the transmission of the second type of frames.

In a ninth aspect according to any one of the first through the seventh aspects, the detection processing may be processing that detects the unauthorized frame on the basis of a number of frames of a first type, and a number of frames of a second type different from the first type, that are transmitted per unit of time. Through this, unauthorized frames can be detected with high accuracy using not only the first type of frames, but also the second type of frames.

In a tenth aspect according to any one of the first through the seventh aspects, the detection processing may be processing that detects the unauthorized frame by comparing a first data value included in a frame of a first type with an estimated value estimated from a second data value included in a frame of a second type different from the first type. Through this, unauthorized frames can be detected with high accuracy using the second data value.

In an eleventh aspect according to any one of the first through the tenth aspects, the relay device may further include a transmission unit configured to, in a case where the unauthorized frame is detected by the detection unit, transmit display information for displaying a notification screen indicating that the unauthorized frame has been detected. Through this, a user can be notified that an unauthorized frame has been detected.

In a twelfth aspect, an unauthorized frame detection method according to the present embodiment is an unauthorized frame detection method for detecting an unauthorized frame by a relay device that, in an in-vehicle network to which a plurality of in-vehicle devices are connected, relays frames among the plurality of in vehicle devices, the unauthorized frame detection method including: a step of, in a case where an unauthorized frame is detected by an in vehicle device among the plurality of in-vehicle devices, receiving a request to start detecting an unauthorized frame from the in-vehicle device; and a step of, in a case where the request to start is received in a stopped state in which detection processing that detects an unauthorized frame among frames transmitted over the in-vehicle network is stopped, transitioning from the stopped state to an executing state in which the detection processing is executed. Through this, the detection processing by the relay device is in the stopped state until an unauthorized frame is detected by an in-vehicle device, and the processing load on the relay device can therefore be suppressed. Furthermore, if the detection processing is executed, unauthorized frames can be detected comprehensively among frames flowing over the in-vehicle network.

In a thirteenth aspect, an in-vehicle device according to the present embodiment is an in-vehicle device connected to an in-vehicle network, the in-vehicle device including: a detection unit configured to detect an unauthorized frame by determining, when a frame transmitted over the in vehicle network is received, whether the frame received is an unauthorized frame; and a transmission unit configured to, in a case where the unauthorized frame is detected by the detection unit, transmit a request to start detecting unauthorized frames to a relay device that relays frames among a plurality of in vehicle devices in the in-vehicle network. Through this, the detection processing by the relay device can be put in the stopped state until an unauthorized frame is detected by an in-vehicle device, and the processing load on the relay device can therefore be suppressed. Furthermore, if the detection processing is executed, unauthorized frames can be detected comprehensively among frames flowing over the in-vehicle network.

The present disclosure can not only be realized as a relay device including the characteristic configurations described above, an unauthorized frame detection method that takes the characteristic processes performed by the relay device as steps, and an in-vehicle device including the characteristic configurations, but can also be realized as an in-vehicle system including the relay device and the in-vehicle device, a unauthorized frame detection program that causes the relay device to execute the characteristic processes, and the like, and some or all of the relay device can be realized as a semiconductor integrated circuit. Furthermore, the present disclosure can be realized as a method taking the characteristic processes performed by the in-vehicle device as steps, as a program for causing the in-vehicle device to execute the characteristic processes, and the like, and some or all of the in-vehicle device can be realized as a semiconductor integrated circuit.

Embodiments of the present disclosure will be described in detail hereinafter with reference to the drawings. Note that the embodiments described hereinafter may be at least partially combined as desired.

### In-Vehicle System

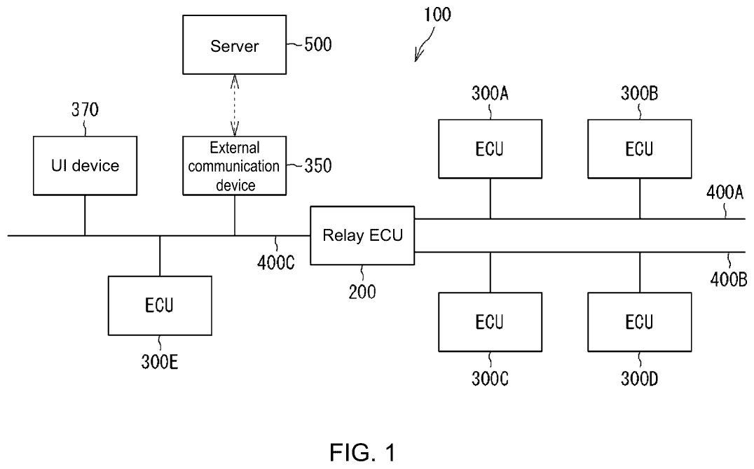

FIG. 1 is a block diagram illustrating an example of the configuration of an in vehicle system according to the present embodiment. An in-vehicle system 100 is installed in a vehicle.

The in-vehicle system 100 according to the present embodiment includes a relay ECU 200 and ECUs 300A, 300B, 300C, 300D, and 300E. The in-vehicle system 100 is an in-vehicle network constituted by the relay ECU 200, the ECUs 300A, 300B, 300C, 300D, and 300E, and a communication line (a communication bus) connecting those elements.

The plurality of ECUs 300A, 300B, 300C, 300D, and 300E are disposed in respective parts of the vehicle. The ECUs 300A, 300B, 300C, 300D, and 300E individually control hardware of each part of the vehicle, monitor the state of the hardware of each part of the vehicle, and the like. For example, the ECUs 300A, 300B, 300C, 300D, and 300E are control-type, body-type, and information-type ECUs. The ECUs 300A, 300B, 300C, 300D, and 300E are examples of “in-vehicle devices”. In the following descriptions, the ECUs 300A, 300B, 300C, 300D and 300E are also collectively referred to as “ECUs 300”.

The relay ECU 200 is connected to each of the ECUs 300A, 300B, 300C, 300D, and 300E by communication buses 400A, 400B, and 400C, such as Controller Area Network (CAN) buses. Specifically, the ECUs 300A and 300B are connected to the bus 400A. The ECUs 300C and 300D are connected to the bus 400B. The ECU 300E is connected to the bus 400C. The relay ECU 200 can communicate with each of the ECUs 300A, 300B, 300C, 300D, and 300E.

The relay ECU 200 and the ECUs 300 use a communication protocol for transmitting and receiving messages periodically or non-periodically. The communication protocol is CAN or CAN with Flexible Data Rate (CAN FD), for example, In another example, the protocol is Ethernet (registered trademark).

The relay ECU 200 functions as a gateway that relays communication among the plurality of ECUs 300. The ECUs 300 can transmit frames. The relay ECU 200 relays frames among ECUs connected to different buses. For example, the relay ECU 200 can relay frames between the ECU 300A connected to the bus 400A and the ECU 300C connected to the bus 400B.

The relay ECU 200 is connected to an external communication device 350 by the bus 400C. The external communication device 350 is a wireless communication terminal compliant with, for example, 5G (the fifth-generation mobile communication system) or 4G (the fourth generation mobile communication system), and is a Telematics Control Unit (TCU), for example. The external communication device 350 can communicate with a server 500. The external communication device 350 relays communication between the relay ECU 200 and the server 500.

The relay ECU 200 is connected to a user interface device (hereinafter also referred to as a “UI device”) 370 by the bus 400C. The UI device 370 is one in-vehicle device installed in the vehicle. The UI device 370 is used by a driver of the vehicle. The UI device 370 includes an input device and a display device, and can accept inputs from the driver and display information to be provided to the driver. For example, the UI device 370 can display information transmitted from the relay ECU 200 or the server 500.

### Relay ECU Configuration

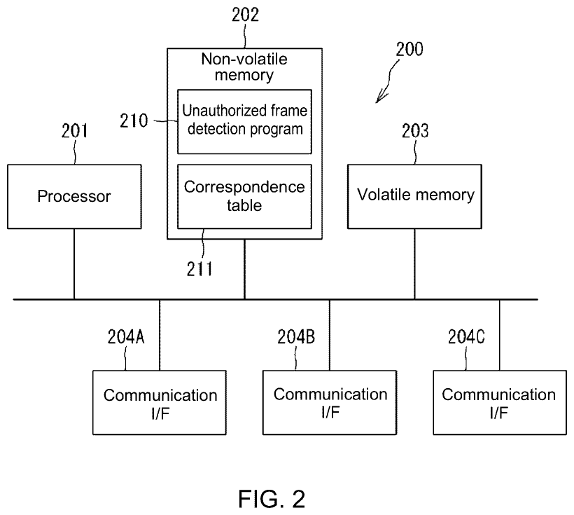

FIG. 2 is a block diagram illustrating an example of the configuration of the relay ECU according to the present embodiment. The relay ECU 200 includes a processor 201, a non-volatile memory 202, a volatile memory 203, and communication interfaces (also called “communication I/Fs” hereinafter) 204A, 204B, and 204C.

The volatile memory 203 is a semiconductor memory such as a Static Random Access Memory (SRAM), a Dynamic Random Access Memory (DRAM), or the like, for example. The non-volatile memory 202 is a flash memory, a hard disk, a Read Only Memory (ROM), or the like, for example. The non-volatile memory 202 stores an unauthorized frame detection program 210, which is a computer program, as well as data used in the execution of the unauthorized frame detection program 210. The functions of the relay ECU 200, which will be described later, are realized by the unauthorized frame detection program 210 being executed by the processor 201.

The processor 201 is a Central Processing Unit (CPU), for example. However, the processor 201 is not limited to a CPU. The processor 201 may be a Graphics Processing Unit (GPU). In one specific example, the processor 201 is a multi-core processor. The processor 201 may be a single core processor. The processor 201 is configured to be capable of executing computer programs. However, the processor 201 may be an Application Specific Integrated Circuit (ASIC), or may be a programmable logic device such as a Field Programmable Gate Array (FPGA), for example. In this case, the ASIC or the programmable logic device is configured to be capable of executing the same functions as the unauthorized frame detection program 210.

The communication I/F's 204A, 204B, and 204C are communication interfaces compliant with the communication protocol for the in vehicle network mentioned above. The communication I/Fs 204A, 204B, and 204C are CAN interfaces, for example. The communication I/Fs 204A, 204B, and 204C may be Ethernet interfaces.

The communication I/F 204A is connected to the bus 400A. The communication I/F 204B is connected to the bus 400B. The communication I/F 204C is connected to the bus 400C. The relay ECU 200 can communicate with the ECUs 300A and 300B through the communication I/F 204A. The relay ECU 200 can communicate with the ECUs 300C and 300D through the communication I/F 204B. The relay ECU 200 can communicate with the ECU 300E through the communication I/F 204C. Furthermore, the relay ECU 200 can communicate with the UI device 370 through the communication I/F 204C, and can communicate with the server 500 through the external communication device 350.

A correspondence table 211 is stored in the non-volatile memory 202. The correspondence table 211 is used by the unauthorized frame detection program 210. The correspondence table 211 will be described later.

### ECU Configuration

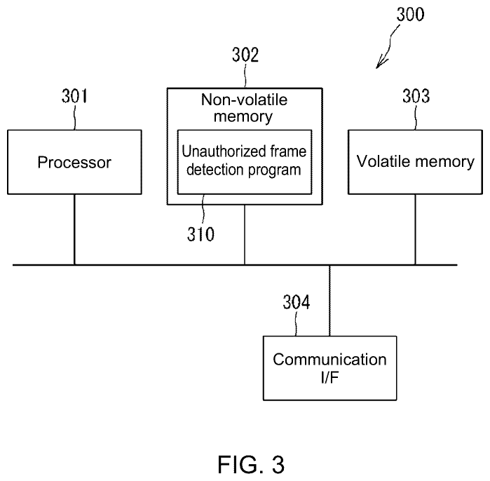

FIG. 3 is a block diagram illustrating an example of the configuration of an ECU according to the present embodiment. The ECU 300 includes a processor 301, a non-volatile memory 302, a volatile memory 303, and a communication I/F 304.

The volatile memory 303 is a semiconductor memory such as an SRAM, a DRAM, or the like, for example. The non-volatile memory 302 is a flash memory, a hard disk, a ROM, or the like, for example. The non-volatile memory 302 stores an unauthorized frame detection program 310, which is a computer program, as well as data used in the execution of the unauthorized frame detection program 310. The functions of the ECU 300, which will be described later, are realized by the unauthorized frame detection program 310 being executed by the processor 301.

The processor 301 is a CPU, for example. However, the processor 301 is not limited to a CPU. The processor 301 may be a GPU. In one specific example, the processor 301 is a multi-core processor. The processor 301 may be a single-core processor. The processor 301 is configured to be capable of executing computer programs. However, the processor 301 may be an ASIC, a programmable logic device such as an FPGA, or the like, for example. In this case, the ASIC or the programmable logic device is configured to be capable of executing the same functions as the unauthorized frame detection program 310.

The communication I/F 304 is a communication interface compliant with the communication protocol for the in-vehicle network mentioned above. The communication I/F 304 is a CAN interface, for example. The communication I/F 304 may be an Ethernet interface.

The communication I/F 304 is connected to the bus 400. The ECU 300 can communicate with the ECUs 300 and the relay ECU 200 through the communication I/F 304.

### Functions of In-Vehicle System

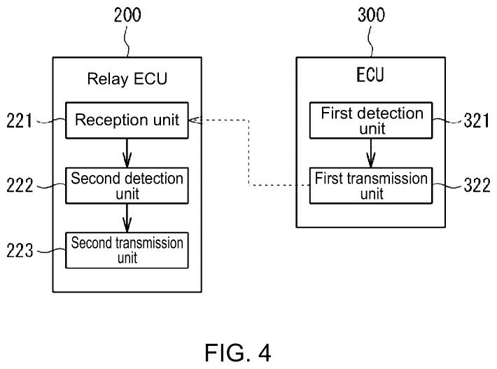

FIG. 4 is a function block diagram illustrating an example of the functions of the in-vehicle system according to the present embodiment.

The functions of a first detection unit 321 and a first transmission unit 322 are realized by the processor 301 of the ECU 300 executing the unauthorized frame detection program 310. The functions of a reception unit 221, a second detection unit 222, and a second transmission unit 223 are realized by the processor 201 of the relay ECU 200 executing the unauthorized frame detection program 310.

In CAN, a frame includes identification information called a CAN ID. The CAN ID indicates the type of the frame. For example, the CAN ID of a frame including data of “engine speed” is “100”, the CAN ID of a frame including data of “accelerator position” is “200”, and the like. The CAN ID also indicates the source of the frame. For example, the CAN ID of a frame transmitted from the ECU 300A is “100”, the CAN ID of a frame transmitted from the ECU 300B is “200”, and the like (see FIG. 1).

For example, an unauthorized frame is transmitted from an unauthorized ECU that is different from the authorized ECUs 300. The unauthorized ECU impersonates an authorized ECU 300 and transmits an unauthorized frame including a CAN ID used by the authorized ECU 300. The unauthorized frame includes unauthorized data.

For example, assume that a frame having a CAN ID of “100” and including data of the engine speed is transmitted from the ECU 300A and received by the ECU 300B. The ECU 300B receives the frame having the CAN ID of “100” in order to use the data of the engine speed for specific processing. In other words, the CAN ID “100” is identification information indicating the source of the frame, and is also identification information indicating the destination of the frame (the ECU 300B). If an unauthorized ECU connected to the bus 400A transmits an unauthorized frame including the CAN ID of “100” to the bus 400A, it is conceivable that the ECU 300B will receive the unauthorized frame and perform processing using the unauthorized data included in the unauthorized frame.

Each ECU 300 has a function for detecting such unauthorized frames. When the ECU 300 receives a frame transmitted over the in vehicle network, the first detection unit 321 of the ECU 300 executes first detection processing of detecting an unauthorized frame by determining whether the received frame is an unauthorized frame.

For example, upon receiving a frame having a CAN ID of “100”, the ECU 300B determines whether the received frame is an unauthorized frame. If the frame is determined to be an unauthorized frame, the CAN ID is used to detect the frame as an unauthorized frame.

If an unauthorized frame is detected in the first detection processing by the first detection unit 321, the first transmission unit 322 transmits, to the relay ECU 200, a detection start request to start detecting the unauthorized frame.

If an unauthorized frame is detected by the ECU 300, the reception unit 221 of the relay ECU 200 receives the detection start request to start detecting the unauthorized frame from the ECU 300.

The second detection unit 222 can execute second detection processing of detecting an unauthorized frame among frames transmitted over the in-vehicle network.

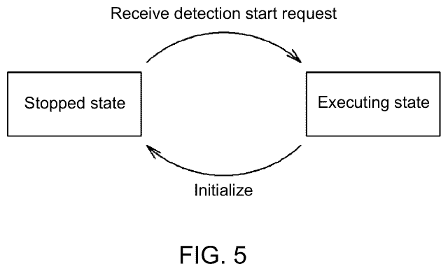

The second detection unit 222 can change the execution state of the second detection processing. FIG. 5 is a state transition diagram illustrating transitions in the execution state of the second detection processing performed by the second detection unit. In an initial state, the state of the second detection unit 222 is a stopped state in which the second detection processing is stopped. When the detection start request is received by the reception unit 221, the second detection unit 222 transitions from the stopped state to an executing state in which the second detection processing is executed. In other words, the second detection unit 222 is triggered to start the second detection processing by the detection start request transmitted from the ECU 300.

Returning to FIG. 4, the second detection unit 222 takes frames transmitted on the bus 400 to which the ECU 300 that is the source of the detection start request is connected as the subject of the second detection processing. For example, if the ECU 300B detects an unauthorized frame in the first detection processing and transmits the detection start request, the second detection unit 222 takes frames transmitted on the bus 400A to which the ECU 300B is connected as the subject of the second detection processing.

In one example, the relay ECU 200 can specify the port (the communication I/F 204) through which the detection start request is received, and the second detection unit 222 can take frames transmitted on the bus 400 connected to the specified port as the subject of the second detection processing. For example, if the communication I/F 204A receives the detection start request, the frames transmitted on the bus 400A are taken as the subject of the second detection processing, In another example, the detection start request may include specifying information specifying the bus 400 to which the ECU 300 that detected the unauthorized frame is connected. For example, if the ECU 300B transmits the detection start request, the detection start request includes specifying information specifying the bus 400A. The relay ECU 200 can take frames flowing over the bus 400A specified by the specifying information included in the detection start request as the subject of the second detection processing.

The detection start request may include a detection result from the ECU 300 detecting the unauthorized frame. Through this, the second detection unit 222 can use the detection result from the first detection processing in the second detection processing,

For example, the first detection processing performed by the first detection unit 321 is processing for simply detecting unauthorized frames, and the second detection processing performed by the second detection unit 222 is processing for comprehensively detecting unauthorized frames.

In a specific example, the first detection processing is processing of detecting unauthorized frames using only frames subject to the unauthorized frame detection (also called “target frames” hereinafter), For example, in the first detection processing executed by the ECU 300B, the frame with the CAN ID of “100” received by the ECU 300B is the target frame, and no frames other than the target frame are used.

On the other hand, the second detection processing is processing of detecting unauthorized frames using frames different from the target frames, i.e., frames that were not subject to the first detection processing, in addition to the target frames.

In one specific example, the second detection unit 222 can take frames relayed among the plurality of ECUs 300 as the subject of the second detection processing. In addition to frames for which the relay ECU 200 itself is the destination, the relay ECU 200 receives frames subject to relay processing. For example, when a frame destined for the ECU 300A from the ECU 300C is transmitted to the bus 400B, the relay ECU 200 receives the frame from the bus 400B and transmits the frame to the bus 400A. Frames received by the relay ECU 200 for such relay processing are also subject to the second detection processing, Accordingly, the second detection processing expands the range of the target frames beyond that of the first detection processing, and unauthorized frames are therefore detected comprehensively.

If an unauthorized frame is detected among the target frames (frames of a first type) by the ECU 300, the second detection processing may be processing of detecting an unauthorized frame from the target frames on the basis of frames of a second type different from the first type. For example, if a frame having a CAN ID of “300” (a frame of the first type) and including data on the vehicle speed is the target frame, the second detection unit 222 can, on the basis of the frame having a CAN ID of “100”, detect the unauthorized frame from a frame having a CAN ID of “300” (a frame of the second type) and including data on the engine speed.

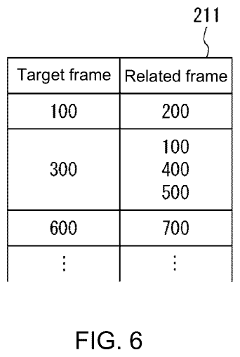

In a more specific example, in the second detection processing, frames related to the target frame (also called “related frames” hereinafter) are used. For example, the second detection unit 222 can specify a related frame using the correspondence table 211 (see FIG. 6).

FIG. 6 is a diagram illustrating an example of the correspondence table. Correspondence relationships between the CAN IDs of target frames and CAN IDs of related frames are defined in the correspondence table 211.

For example, the engine speed changes in accordance with the accelerator position. In other words, the accelerator position is related to the engine speed. Accordingly, a frame having a CAN ID of “100” and including data on the engine speed is related to a frame having a CAN ID of “200” and including data on the accelerator position. The CAN ID of “200” of the related frame is associated with the CAN ID of “100” of the target frame in the correspondence table 211.

For example, the vehicle speed varies depending on the engine speed, the shift position, and the state of the brakes. In other words, the engine speed, the shift position, and the braking state are related to the vehicle speed. Accordingly, a frame having a CAN ID of “300” and including data on the vehicle speed is related to a frame having a CAN ID of “100” and including data on the engine speed, a frame having a CAN ID of “400” and including data on the shift position, and a frame having a CAN ID of “500” and including data on the braking state. The CAN ID of “300” of the target frame is associated with the CAN IDs of “100”, “400”, and “500” of the related frames in the correspondence table 211.

For example, when an occupant such as a driver gets on or off the vehicle, the occupant's seatbelt is removed; the occupant puts their seatbelt on after entering the vehicle. In other words, the attachment/detachment state of the seatbelt, i.e., worn or not worn, is related to the opening/closing state of the door, i.e., open or closed. Accordingly, a frame having a CAN ID of “600” and including data on the opening/closing state of the door is related to a frame having a CAN ID of “700” and including data on the attachment/detachment state of the seatbelt. The CAN ID of “600” of the target frame is associated with the CAN ID of “700” of the related frame in the correspondence table 211.

Returning to FIG. 4, if the reception unit 221 has received the detection start request transmitted from the first transmission unit 322 of the ECU 300, the second detection unit 222 can determine the CAN ID of the related frame from the correspondence table 211 on the basis of the CAN ID of the target frame in the first detection processing in which the unauthorized frame was detected.

The second detection processing may be processing that detects the unauthorized frame from target frames on the basis of the timing of the transmission of the target frame (the frames of the first type) and the timing of the transmission of the related frames (the frames of the second type). In this case, the simple first detection processing may be processing that detects the unauthorized frame from the target frames on the basis of the transmission timing of the target frames only.

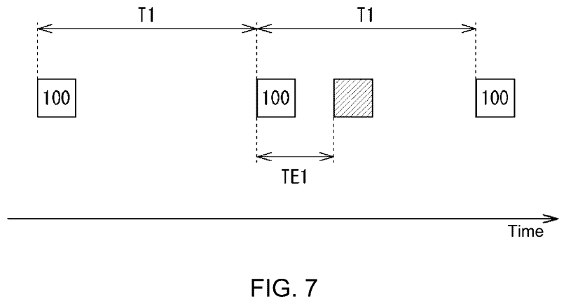

FIG. 7 is a diagram illustrating an example of the first detection processing. The example in FIG. 7 is processing that focuses on the periodicity of CAN frames. In CAN, frames having the same CAN ID are transmitted at a set period. In the example in FIG. 7, a frame having a CAN ID of “100” (indicated by a square mark labeled “100” in the figure) is repeatedly transmitted at a period T1. When an unauthorized frame having a CAN ID of “100” (indicated by a hatched square mark in the figure) is inserted, an interval TEl between an authorized frame and the unauthorized frame is different from the period T1. In the first detection processing, the first detection unit 321 detects the unauthorized frame when the timing of the transmission of the frame having a CAN ID of “100” has deviated from the period T1.

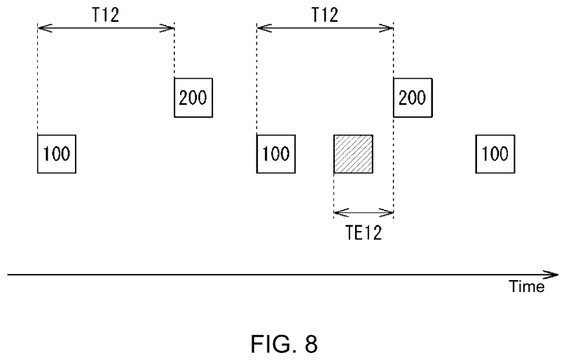

FIG. 8 is a diagram illustrating an example of the second detection processing. The example in FIG. 8 is processing that focuses on the periodicity of CAN frames. In the example in FIG. 8, the transmission period of the frame having a CAN ID of “100” is the same as the transmission period of the frame having a CAN ID of “200” (indicated by a square mark labeled “200” in the figure). In this case, an interval T12 between the frame having a CAN ID of “100” and the frame having a CAN ID of “200” is a constant value. When an unauthorized frame having a CAN ID of “100” is inserted, an interval TE12 between an authorized frame having a CAN ID of “200” and the unauthorized frame is different from the interval T12. In the second detection processing, the second detection unit 222 detects an unauthorized frame when the interval between the frame having a CAN ID of “100” and the frame having a CAN ID of “200” deviates from the constant interval TE12.

The second detection processing may be processing that takes frames of the first type and frames of the second type, respectively, as the target frames, and detects the unauthorized frame on the basis of a number of the target frames transmitted per unit of time. In this case, the simple first detection processing may be processing that takes only frames of the first type as the target frames, and detects the unauthorized frame on the basis of a number of the target frames transmitted per unit of time.

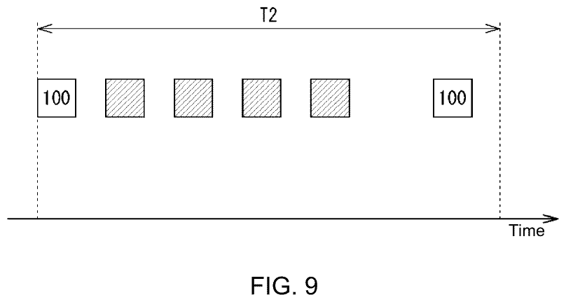

FIG. 9 is a diagram illustrating another example of the first detection processing. The example in FIG. 9 is processing that focuses on the load on the bus (the number of frames transmitted). In CAN, frames may be transmitted non-periodically. For example, there are event driven frame transmissions, in which frames are transmitted in response to a specific event serving as a trigger. For example, if an upper limit value of the number of authorized event-driven frames transmitted per unit of time is known, the upper limit value can be used to detect unauthorized frames. In the example in FIG. 9, an upper limit value for the number of times an event-driven frame having a CAN ID of “100” is transmitted per unit of time T2 is “4”, and the upper limit value “4” is taken as a reference value. When one or more unauthorized frames having a CAN ID of “100” are inserted, the number of frames having a CAN ID of “100”, including unauthorized frames, transmitted per unit of time T2 will exceed a reference value. In the first detection processing, the first detection unit 321 detects an unauthorized frame when the number of frames having a CAN ID of “100” transmitted per unit of time exceeds the reference value.

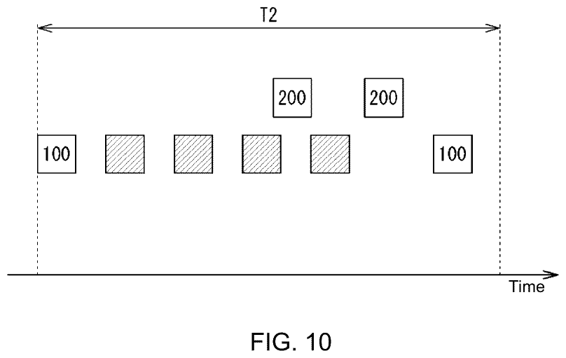

FIG. 10 is a diagram illustrating an example of the second detection processing. The example in FIG. 10 is processing that focuses on the load on the bus (the number of frames transmitted). In the example in FIG. 10, the upper limit value for the number of event-driven frames having a CAN ID of “100” and event-driven frames having a CAN ID of “200” transmitted per unit of time T2 is “6”, and the upper limit value of “6” is taken as the reference value. When an unauthorized frame having a CAN ID of “100” is inserted, the number of frames having CAN IDs of “100” and “200”, including unauthorized frames, transmitted per unit of time T2 will exceed the reference value. In the second detection processing, the second detection unit 222 detects an unauthorized frame when the number of frames having CAN IDs of “100” and “200” transmitted per unit of time exceeds the reference value.

Returning to FIG. 4, the second detection processing is processing that detects an unauthorized frame by comparing a first data value included in the target frame (a frame of the first type) with an estimated value estimated from a second data value included in a related frame (a frame of the second type). In this case, the simple first detection processing may be processing that detects an unauthorized frame by comparing the first data value included in the target frame (a most recent value) with an estimated value estimated from the first data value included in the previous target frame (a second most recent value).

For example, when a frame having a CAN ID of “100” and including the data value of the engine speed is the target frame, the first detection unit 321 estimates the most recent value from the second most recent value of the engine speed. In a specific example, the estimated value for the current value can be calculated by adding, to the second most recent value, the value of the difference between the third most recent value and the second most recent value of the engine speed. In the first detection processing, the first detection unit 321 detects an unauthorized frame when the difference between the most recent value of the engine speed and the estimated value exceeds a permissible range.

For example, when a frame having a CAN ID of “100” and including the data value of the engine speed is taken as the target frame, the second detection unit 222 takes a frame having a CAN ID of “200” and including the data value of the accelerator position as a related frame, and estimates the engine speed from the data value of the accelerator position. In a specific example, the engine speed can be estimated from the accelerator position on the basis of a predetermined correspondence relationship between engine speeds and accelerator positions. In the second detection processing, the second detection unit 222 detects an unauthorized frame when the difference between the data value of the engine speed and the estimated value exceeds a permissible range.

When an unauthorized frame is detected by the second detection unit, the second transmission unit 223 transmits, to the UI device 370, display information for displaying a notification screen indicating that an unauthorized frame has been detected.

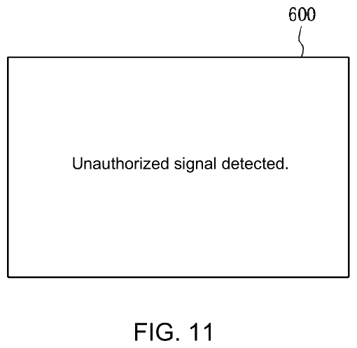

FIG. 11 is a diagram illustrating an example of the notification screen. Upon receiving the display information, the UI device 370 displays a notification screen 600. The notification screen 600 illustrated in FIG. 11 includes text information reading “unauthorized signal detected”. With this text information, the driver can be notified that an unauthorized frame (signal) has been detected.

If an unauthorized frame is detected by the second detection unit, the second transmission unit 223 may transmit a result of detecting the unauthorized frame to the server 500. The server 500 stores the received result of detecting the unauthorized frame, and notifies a dealer (a management device installed with the dealer or a mobile terminal of a worker at the dealer) that an unauthorized frame has been detected. For example, the worker at the dealer can confirm the result of detecting the unauthorized frame and notify the driver that maintenance is required. Through this, when the vehicle undergoes maintenance at the dealer, the worker can reset the relay ECU 200 after taking necessary measures, such as removing the unauthorized ECU. Referring to FIG. 5, when the relay ECU 200 is reset, the second detection unit 222 transitions from the executing state, in which the second detection processing is executed, to the stopped state.

### Operations by In-Vehicle System

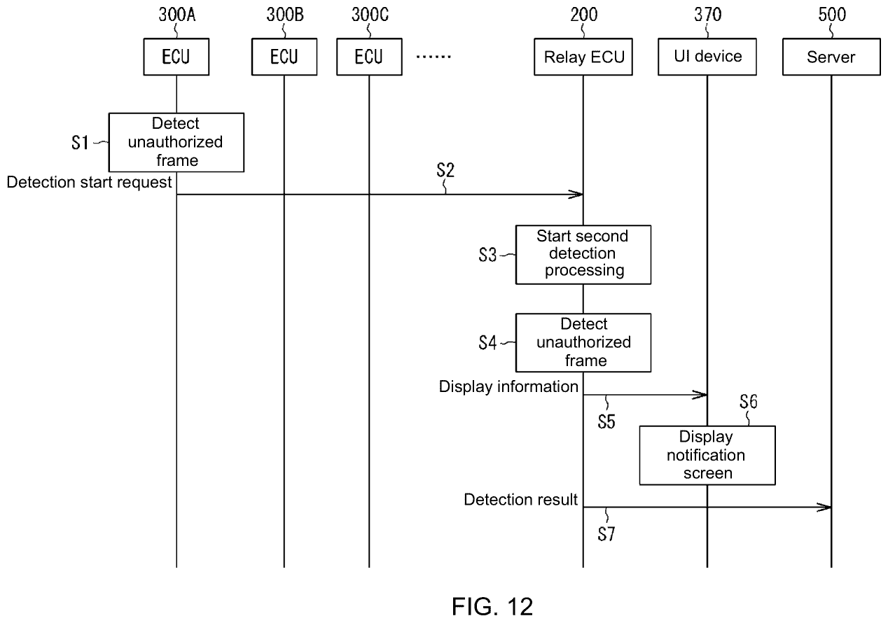

Operations by the in-vehicle system according to the present embodiment will be described hereinafter. FIG. 12 is a sequence chart illustrating an example of the operations by the in vehicle system according to the present embodiment.

Each ECU 300 executes the first detection processing. At this point, the relay ECU 200 has stopped the second detection processing (is in the stopped state). In the example in FIG. 12, the ECU 300A detects an unauthorized frame (step S1). The processor 301 of the ECU 300A transmits a detection start request to the relay ECU 200 (step S2).

When the relay ECU 200 receives the detection start request, the processor 201 starts the second detection processing (step S3). Through this, the processor 201 transitions from the stopped state, in which the second detection processing is stopped, to the executing state.

Upon detecting an unauthorized frame through the second detection processing (step S4), the processor 201 transmits the display information to the UI device 370 (step S5). Upon receiving the display information, the UI device 370 displays the notification screen 600 (step S6). This makes it possible to notify the driver that an unauthorized frame has been detected.

The processor 201 transmits the result of detecting the unauthorized frame to the server 500 (step S7). Upon receiving the result of detecting the unauthorized frame, the server 500 stores the received result. Furthermore, the server 500 notifies the dealer that an unauthorized frame has been detected. This enables a worker at the dealer to contact the driver and notify the driver that maintenance is required.

During the maintenance work on the vehicle, the unauthorized ECU is removed and the relay ECU 200 is initialized. The second detection processing by the relay ECU 200 returns to the stopped state as a result.

### Supplementary Note 1

A computer program for causing a relay device that, in an in vehicle network to which a plurality of in-vehicle devices are connected, relays frames among the plurality of in-vehicle devices to detect an unauthorized frame, the computer program causing a computer to execute:
a step of, when an unauthorized frame is detected by an in vehicle device among the plurality of in vehicle devices, receiving a request to start detecting an unauthorized frame from the in-vehicle device; and
a step of, when the request to start is received in a stopped state in which detection processing that detects an unauthorized frame among frames transmitted over the in vehicle network is stopped, transitioning from the stopped state to an executing state in which the detection processing is executed.

### Supplementary Note 2

A computer program for controlling an in-vehicle device connected to an in vehicle network, the computer program causing a computer to execute:
a step of detecting an unauthorized frame by determining, when a frame transmitted over the in-vehicle network is received, whether the frame received is an unauthorized frame; and
a step of, when the unauthorized frame is detected, transmitting a request to start detecting unauthorized frames to a relay device that relays frames among a plurality of in vehicle devices in the in-vehicle network.

### Supplementary Note 3

A control method for controlling an in-vehicle device connected to an in-vehicle network, the control method including:
a step of detecting an unauthorized frame by determining, when a frame transmitted over the in vehicle network is received, whether the frame received is an unauthorized frame; and
a step of, when the unauthorized frame is detected, transmitting a request to start detecting unauthorized frames to a relay device that relays frames among a plurality of in-vehicle devices in the in-vehicle network.

### Supplementary Note 4

An in-vehicle system including:
a plurality of in vehicle devices connected to an in-vehicle network; and
a relay device that, in the in-vehicle network, relays frames among the plurality of in-vehicle devices,
wherein the in-vehicle device includes:
   a first detection unit configured to detect an unauthorized frame by determining, when a frame transmitted over the in-vehicle network is received, whether the frame received is an unauthorized frame; and
   a first transmission unit configured to, when the unauthorized frame is detected by the first detection unit, transmit a request to start detecting unauthorized frames to the relay device,
the relay device includes:
   a reception unit configured to receive the request to start from the in-vehicle device; and
   a second detection unit capable of executing detection processing that detects an unauthorized frame among frames transmitted over the in-vehicle network, and
when the request to start is received by the reception unit in a stopped state in which the detection processing is stopped, the second detection unit transitions from the stopped state to an executing state in which the detection processing is executed.

### Additional Information

The embodiments disclosed herein are in all ways exemplary and in no way limiting. The scope of rights of the present disclosure is defined not by the foregoing embodiments but by the scope of the claims, and includes all changes equivalent in meaning to and falling within the scope of the claims.

1. A relay device that, in an in-vehicle network to which a plurality of in-vehicle devices are connected, relays frames among the plurality of in-vehicle devices, the relay device comprising:
a reception unit configured to, in a case where an unauthorized frame is detected by an in-vehicle device among the plurality of in-vehicle devices, receive a request to start detecting an unauthorized frame from the in-vehicle device; and
a detection unit capable of executing detection processing that detects an unauthorized frame among frames transmitted over the in-vehicle network,
wherein in a case where the request to start is received by the reception unit in a stopped state in which the detection processing is stopped, the detection unit transitions from the stopped state to an executing state in which the detection processing is executed.

2. The relay device according to claim 1,
wherein the relay device is connected to a plurality of communication lines constituting the in-vehicle network, and
the detection unit takes frames transmitted on a communication line, among the plurality of communication lines, to which the in-vehicle device that transmitted the request to start is connected, as a subject of the detection processing.

3. The relay device according to claim 2, wherein the request to start includes specifying information specifying a communication line, among the plurality of communication lines, to which the in-vehicle device that has detected the unauthorized frame is connected.

4. The relay device according to claim 1, wherein the request to start includes a result of detecting the unauthorized frame by the in-vehicle device.

5. The relay device according to claim 1, wherein the detection unit takes the frames relayed among the plurality of in-vehicle devices as a subject of the detection processing.

6. The relay device according to claim 1, wherein the detection processing is processing that, in a case where the unauthorized frame is detected by the in-vehicle device among frames of a first type, detects the unauthorized frame among frames of the first type on the basis of frames of a second type different from the first type.

7. The relay device according to claim 1, wherein the detection processing is processing that detects the unauthorized frame among frames of a plurality of types.

8. The relay device according to claim 1, wherein the detection processing is processing that, on the basis of a timing of transmission of frames of a first type and a timing of transmission of frames of a second type different from the first type, detects the unauthorized frame among frames of the first type.

9. The relay device according to claim 1, wherein the detection processing is processing that detects the unauthorized frame on the basis of a number of frames of a first type, and a number of frames of a second type different from the first type, that are transmitted per unit of time.

10. The relay device according to claim 1, wherein the detection processing is processing that detects the unauthorized frame by comparing a first data value included in a frame of a first type with an estimated value estimated from a second data value included in a frame of a second type different from the first type.

11. The relay device according to claim 1, further including;
a transmission unit configured to, in a case where the unauthorized frame is detected by the detection unit, transmit display information for displaying a notification screen indicating that the unauthorized frame has been detected.

12. An unauthorized frame detection method for detecting an unauthorized frame by a relay device that, in an in-vehicle network to which a plurality of in-vehicle devices are connected, relays frames among the plurality of in-vehicle devices, the unauthorized frame detection method comprising:
a step of, in a case where an unauthorized frame is detected by an in-vehicle device among the plurality of in-vehicle devices, receiving a request to start detecting an unauthorized frame from the in-vehicle device; and
a step of, in a case where the request to start is received in a stopped state in which detection processing that detects an unauthorized frame among frames transmitted over the in-vehicle network is stopped, transitioning from the stopped state to an executing state in which the detection processing is executed.

13. An in-vehicle device connected to an in-vehicle network, the in-vehicle device comprising:
a detection unit configured to detect an unauthorized frame by determining, in a case where a frame transmitted over the in-vehicle network is received, whether the frame received is an unauthorized frame; and
a transmission unit configured to, in a case where the unauthorized frame is detected by the detection unit, transmits a request to start detecting unauthorized frames to a relay device that relays frames among a plurality of in-vehicle devices in the in-vehicle network.
